(19) United States
(12) Patent Application Publication
(10) Pub. No.: US 2016/0139259 A1
(43) Pub. Date: May 19, 2016

(54) MODULAR SUPERHETERODYNE STEPPED FREQUENCY RADAR SYSTEM FOR IMAGING

(71) Applicant: NORTHEASTERN UNIVERSITY, Boston, MA (US)

(72) Inventors: Carey Rappaport, Boston, MA (US); Spiros Mantzavinos, Boston, MA (US); Borja Gonzalez Valdes, Boston, MA (US); Jose Angel Martinez, Boston, MA (US); Dan Busuioc, Boston, MA (US)

(21) Appl. No.: 14/903,687

(22) PCT Filed: Jul. 15, 2014
(86) PCT No.: PCT/US14/46585

§ 371 Date: Jan. 8, 2016

Related U.S. Application Data
(60) Provisional application No. 61/846,215, filed on Jul. 15, 2013.

(51) Int. Cl. G01S 13/89; G01S 13/02

(52) U.S. Cl. CPC G01S 13/89; G01S 13/0209

(57) ABSTRACT

In some aspects, the disclosure is directed methods and systems for establishing a wideband radar system for imaging. A receiver of a radar imaging system may receive a set of phase measurements for each of a plurality of frequency bands, each of the plurality of frequency bands established by up-converting or down-converting a base frequency band. A phase adjuster of the radar imaging system may identify, from each region of overlap between consecutive frequency bands of the plurality of frequency bands, a phase difference between corresponding sets of the phase measurements. The phase adjuster may adjust one or more sets of the phase measurements based on the identified phase differences to generate an image across the plurality of frequency bands.

### RELATED APPLICATION

This application claims priority to U.S. Provisional Patent Application No. 61/846,215, entitled “Modular Superheterodyne Stepped Frequency Radar System for Imaging”, filed Jul. 15, 2013, which is incorporated herein by reference in its entirety for all purposes.

### GOVERNMENT SUPPORT

This invention was made with government support under 2008-ST-061-ED0001 awarded by the U.S. Department of Homeland Security (DHS). The government has certain rights in the invention.

### FIELD OF THE DISCLOSURE

This disclosure generally relates to systems and methods for performing radar-based imaging. In particular, this disclosure relates to systems and methods for establishing wideband radar for imaging.

### BACKGROUND OF THE DISCLOSURE

In conventional systems utilizing radar imaging for surveillance and detection purposes, an object of interest may be illuminated (e.g., using millimeter wave) and the scattered field measured and processed to reconstruct a feature of the object. These systems may generate an image that profiles a detectable shape, outline and/or movement of an object. Conventional radar systems, however, may achieve a suitably wide bandwidth at a high cost to the hardware architecture. For example, these systems may need highly customized, tuned and calibrated sub-components to ensure that all subcomponents function appropriately across the desired range or band. Moreover, conventional radar systems are typically implemented using complex homodyne architectures, which may impose limitations to possible configurations in bistatic and multistatic implementations. System performance of such systems may also be highly dependent on complex or expensive synchronization between transmitting and receiving modules.

### BRIEF SUMMARY OF THE DISCLOSURE

Described herein are systems and methods for establishing wideband radar for imaging an object or region of interest. The present systems and method may incorporate a heterodyne or modular multi-bandwidth architecture to expand the total operating system bandwidth of a narrowband system or source. Using frequency conversion, a plurality of frequency bands may be established from a base frequency band. Phase differences detected between the plurality of frequency bands can be removed or minimized using phase values from overlapping regions between the plurality of frequency bands, so that the phase values can be adjusted and coherently processed into an image corresponding to an object or region being scanned, e.g., for security or surveillance purposes. The present architecture and/or solution can allow low frequency clocks to be used, so that synchronization between transmitting and receiving modules can be performed relatively easily and/or at low cost, for example using conventional coaxial cable or wirelessly. This can impart flexibility in system configuration to allow many bistatic and/or multistatic implementations over a variety of applications and operational conditions.

In some aspects, the present disclosure pertains to a method for establishing a wideband radar system for imaging. A receiver of a radar imaging system may receive a set of phase measurements for each of a plurality of frequency bands, each of the plurality of frequency bands established by up-converting or down-converting a base frequency band. A phase adjuster of the radar imaging system may identify, from each region of overlap between consecutive frequency bands of the plurality of frequency bands, a phase difference between corresponding sets of the phase measurements. The phase adjuster may adjust one or more sets of the phase measurements based on the identified phase differences to generate an image across the plurality of frequency bands.

In some embodiments, the receiver may receive a signal produced from a signal transmitted from a transmitter of the radar imaging system at a corresponding frequency band of the plurality of frequency bands, wherein the transmitter is located at a first location and the receiver is located at a second location spatially separated from the first location. A same reference clock corresponding to the base frequency band may be provided, wirelessly or via coaxial cable, to the receiver and the transmitter. The receiver receiving the set of phase measurements may comprise a receiver of a multistatic or bistatic radar imaging system. The receiver may receive a set of phase measurements for each of the plurality of frequency bands, the plurality of frequency bands forming a continuous frequency band with a center frequency between 50 GHz and 80 GHz.

In some embodiments, a frequency conversion module of the radar imaging system establishes the plurality of frequency bands. Each of the plurality of frequency bands may have at least a predefined extent of overlap with at least another of the plurality of frequency bands. The phase adjuster may identify, at a frequency within the region of overlap, a difference in phase values between the corresponding sets of the phase measurements. The phase adjuster may minimize differences between the sets of phase measurements within the regions of overlap. The phase adjuster may generate a combined or continuous set of phase measurements across the plurality of frequency bands, based on removal or minimization of each identified phase difference. The radar imaging system may generate the image based on the combined or continuous set of phase measurements.

In certain aspects, the present disclosure pertains to a wideband radar system for imaging. The system may include a receiver receiving a set of phase measurements for each of a plurality of frequency bands. A frequency conversion module for the receiver may establish each of the plurality of frequency bands by up-converting or down-converting a base frequency band. A phase adjuster may identify, from each region of overlap between consecutive frequency bands of the plurality of frequency bands, a phase difference between corresponding sets of the phase measurements. The phase adjuster may adjust one or more sets of the phase measurements based on the identified phase differences to generate an image across the plurality of frequency bands.

In certain embodiments, the receiver receives a signal produced from a signal transmitted from a transmitter of the radar imaging system at a corresponding frequency band of the plurality of frequency bands. The transmitter may be located at a first location and the receiver located at a second location spatially separated from the first location. The frequency conversion module for the receiver and a frequency conversion module for the transmitter may receive a same reference clock wirelessly or via coaxial cable. The reference clock may correspond to the base frequency band. The receiver may comprise a receiver of a multistatic or bistatic radar imaging system. The receiver may receive a set of phase measurements for each of the plurality of frequency bands, the plurality of frequency bands forming a continuous frequency band with a center frequency between 50 GHz and 80 GHz.

In some embodiments, the frequency conversion module establishes the plurality of frequency bands. Each of the plurality of frequency bands may have at least a predefined extent of overlap with at least another of the plurality of frequency bands. The phase shifter may identify, at a frequency within the region of overlap, a difference in phase values between the corresponding sets of the phase measurements. The phase shifter may minimize differences between the sets of phase measurements within the regions of overlap. The phase shifter may generate a combined or continuous set of phase measurements across the plurality of frequency bands, based on removal or minimization of each identified phase difference. The radar imaging system may generate the image based on the combined or continuous set of phase measurements.

The details of various embodiments of the invention are set forth in the accompanying drawings and the description below.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIG. 2A is a block diagram depicting one embodiment of a system a wideband radar system for imaging;

FIGS. 2B and 2C are block diagrams depicting embodiments of block diagrams of a wideband radar system for imaging;

FIG. 2D depicts an illustrative embodiment of connections related to the transmitter module;

FIG. 2E depicts one embodiment of a superheterodyne system which may be suitable for use in certain embodiments of the present systems;

FIG. 2F depicts one embodiment of phase measurements acquired for frequencies across two bands;

FIG. 2G depicts one embodiment of phase measurements acquired for frequencies across two bands that are adjusted for a phase offset between the two bands;

FIG. 2H depicts one illustrative embodiment of synchronized operation between bands of a transmitter and a receiver; and

FIG. 2I shows one embodiment of a method for establishing a wideband radar system for imaging.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for establishing wideband radar for imaging.

### A. Computing and Network Environment

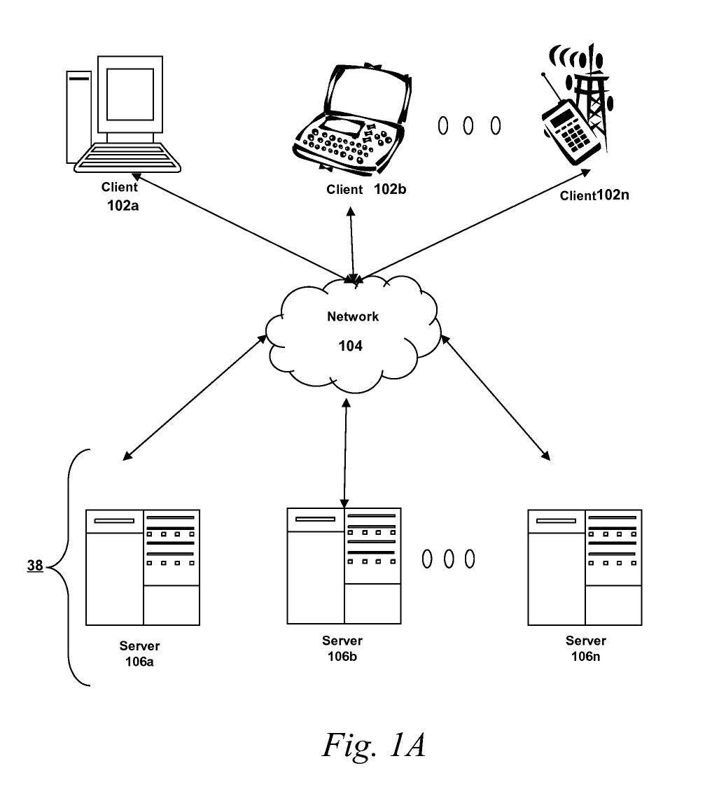

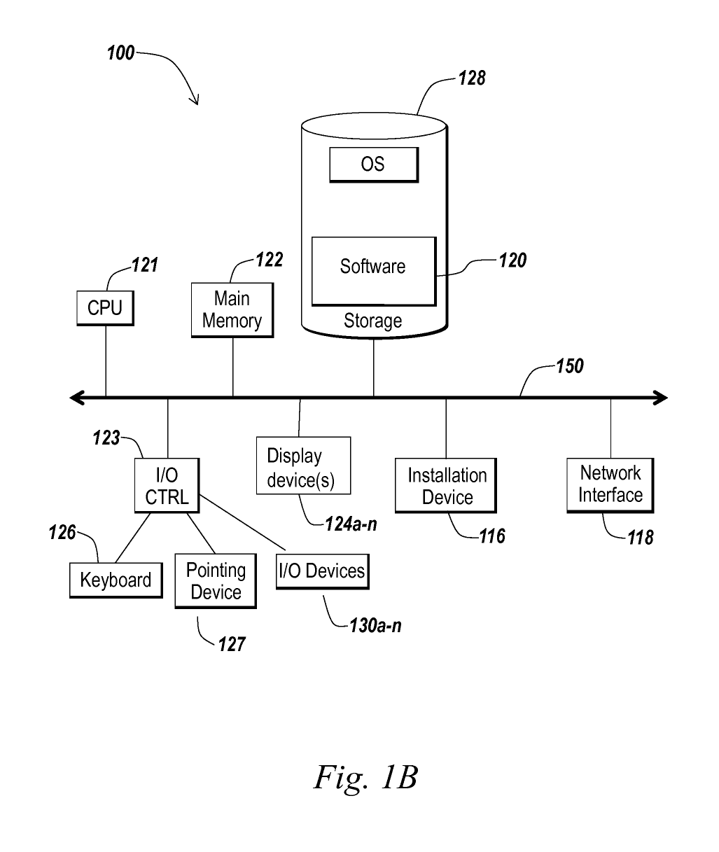

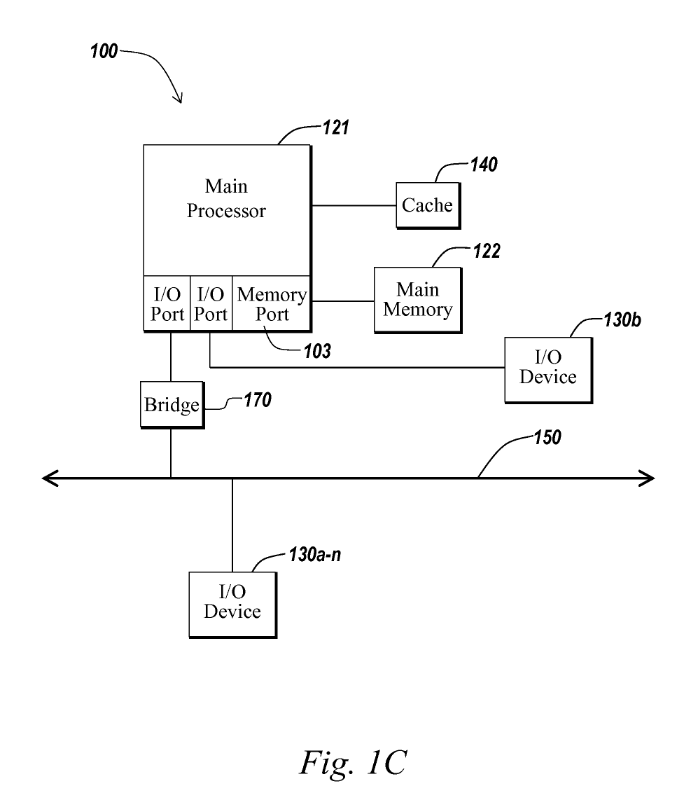

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 101a-101n (also generally referred to as local machine(s) 101, client(s) 101, client node(s) 101, client machine(s) 101, client computer(s) 101, client device(s) 101, endpoint(s) 101, or endpoint node(s) 101) in communication with one or more servers 106a-106n (also generally referred to as server(s) 106, node 106, or remote machine(s) 106) via one or more networks 104. In some embodiments, a client 101 has the capacity to function as both a client node seeking access to resources provided by a server and as a server providing access to hosted resources for other clients 101a-101n.

Although FIG. 1A shows a network 104 between the clients 101 and the servers 106, the clients 101 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 101 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol(s) or standard(s) used to communicate among mobile devices, including AMPS, TDMA, CDMA, GSM, GPRS, UMTS, WiMAX, 3G or 4G. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the Virtual Server or virtual PC hypervisors provided by Microsoft or others.

In order to manage a machine farm 38, at least one aspect of the performance of servers 106 in the machine farm 38 should be monitored. Typically, the load placed on each server 106 or the status of sessions running on each server 106 is monitored. In some embodiments, a centralized service may provide management for machine farm 38. The centralized service may gather and store information about a plurality of servers 106, respond to requests for access to resources hosted by servers 106, and enable the establishment of connections between client machines 101 and servers 106.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

In one embodiment, the server 106 provides the functionality of a web server. In another embodiment, the server 106a receives requests from the client 101, forwards the requests to a second server 106b and responds to the request by the client 101 with a response to the request from the server 106b. In still another embodiment, the server 106 acquires an enumeration of applications available to the client 101 and address information associated with a server 106′ hosting an application identified by the enumeration of applications. In yet another embodiment, the server 106 presents the response to the request to the client 101 using a web interface. In one embodiment, the client 101 communicates directly with the server 106 to access the identified application. In another embodiment, the client 101 receives output data, such as display data, generated by an execution of the identified application on the server 106.

The client 101 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 101 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-101n, a keyboard 126 and a pointing device 127, such as a mouse. The storage device 128 may include, without limitation, an operating system and/or software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), NAND Flash, NOR Flash and Solid State Drives (SSD). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 may communicate directly with I/O device 130b, for example via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, touch pads, and drawing tablets. Output devices include video displays, speakers, inkjet printers, laser printers, projectors and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a disk drive, a CD-ROM drive, a CD-R/RW drive, a DVD-ROM drive, a flash memory drive, tape drives of various formats, USB device, hard-drive or any other device suitable for installing software and programs. The computing device 100 can further include a storage device, such as one or more hard disk drives or redundant arrays of independent disks, for storing an operating system and other related software, and for storing application software programs such as any program or software 120 for implementing (e.g., configured and/or designed for) the systems and methods described herein. Optionally, any of the installation devices 116 could also be used as the storage device. Additionally, the operating system and the software can be run from a bootable medium, for example, a bootable CD.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, manufactured by Google Inc; WINDOWS 7 and 8, manufactured by Microsoft Corporation of Redmond, Wash.; MAC OS, manufactured by Apple Computer of Cupertino, Calif.; WebOS, manufactured by Research In Motion (RIM); OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPAD or IPOD family of devices manufactured by Apple Computer of Cupertino, Calif., a device of the PLAYSTATION family of devices manufactured by the Sony Corporation of Tokyo, Japan, a device of the NINTENDO/Wii family of devices manufactured by Nintendo Co., Ltd., of Kyoto, Japan, or an XBOX device manufactured by the Microsoft Corporation of Redmond, Wash.

In some embodiments, the computing device 100 may have different processors, operating systems, and input devices consistent with the device. For example, in one embodiment, the computing device 100 is a smart phone, mobile device, tablet or personal digital assistant. In still other embodiments, the computing device 100 is an Android-based mobile device, an iPhone smart phone manufactured by Apple Computer of Cupertino, Calif., or a Blackberry handheld or smart phone, such as the devices manufactured by Research In Motion Limited. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a tablet such as the Apple IPAD, or a digital audio player such as the Apple IPOD lines of devices, manufactured by Apple Computer of Cupertino, Calif. In another of these embodiments, the digital audio player may function as both a portable media player and as a mass storage device. In other embodiments, the computing device 100 is a digital audio player such as an MP3 players. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the communications device 101 includes a combination of devices, such as a mobile phone combined with a digital audio player or portable media player. In one of these embodiments, the communications device 101 is a smartphone, for example, an iPhone manufactured by Apple Computer, or a Blackberry device, manufactured by Research In Motion Limited. In yet another embodiment, the communications device 101 is a laptop or desktop computer equipped with a web browser and a microphone and speaker system, such as a telephony headset. In these embodiments, the communications devices 101 are web-enabled and can receive and initiate phone calls.

In some embodiments, the status of one or more machines 101, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Establishing Wideband Radar for Imaging

Described herein are systems and methods for establishing wideband radar for imaging an object or region of interest. Applications for the present systems and methods may include, but are not limited to detection of objects, features or material, for security and surveillance purposes for example. Embodiments of the present systems and methods may be incorporated into nearfield and/or far-field scanning and imaging systems, for example for deployment in airports, transportation venues, secure facilities, government buildings, and building entrances.

The present systems and method may incorporate a heterodyne or modular multi-bandwidth architecture to expand the total operating system bandwidth of a narrowband system or source. Using frequency conversion, a plurality of frequency bands may be established from a base frequency band. Phase differences detected between the plurality of frequency bands can be removed or minimized using phase values from overlapping regions between the plurality of frequency bands, so that the phase values can be adjusted and coherently processed into an image corresponding to an object or region being scanned. The present architecture and/or solution can allow low frequency clocks to be used, so that synchronization between transmitting and receiving modules can be performed relatively easily and/or at low cost, for example using conventional flexible RF coaxial cable, or wirelessly. This can impart flexibility in system configuration to allow many bistatic and/or multistatic implementations over a wide variety of applications, operational conditions and spatial arrangements/distances.

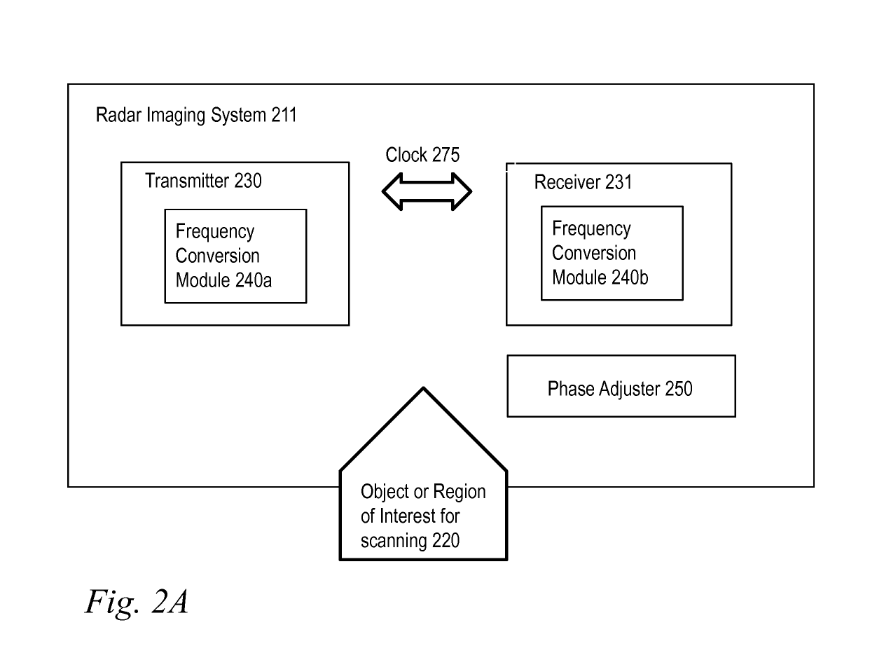

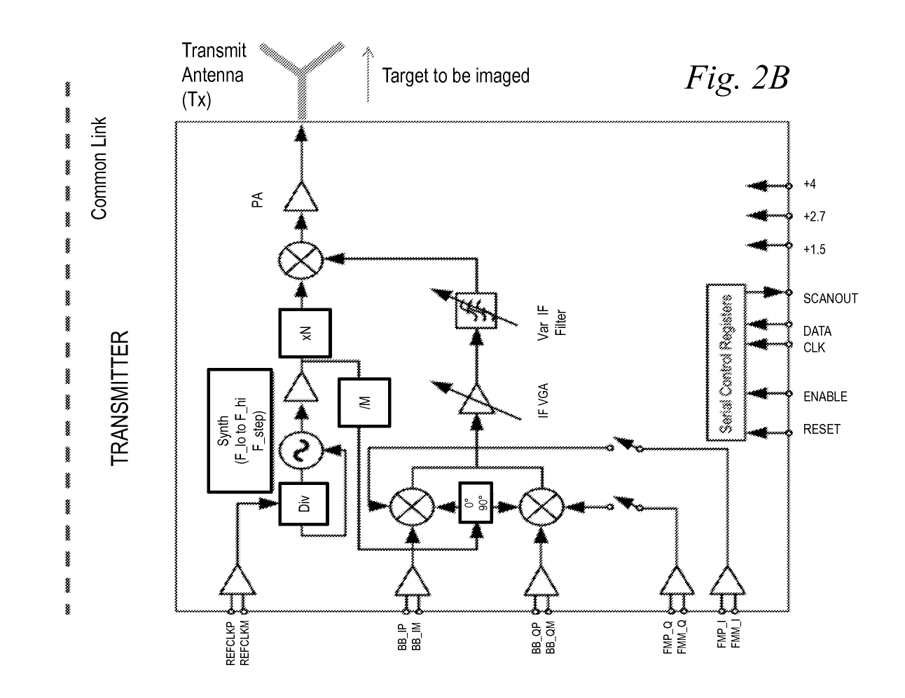

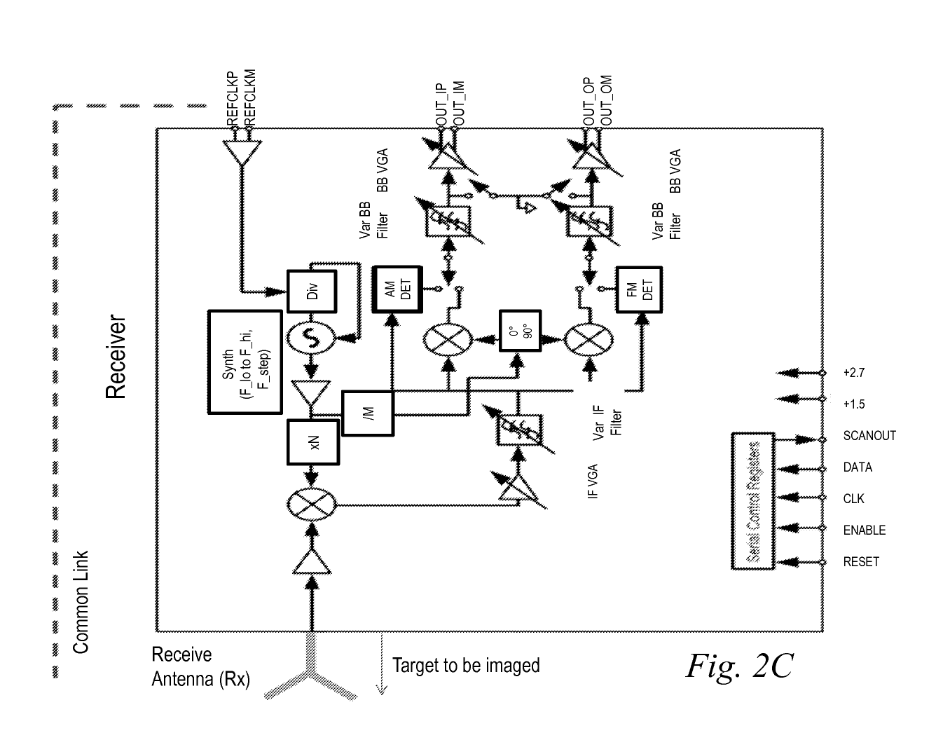

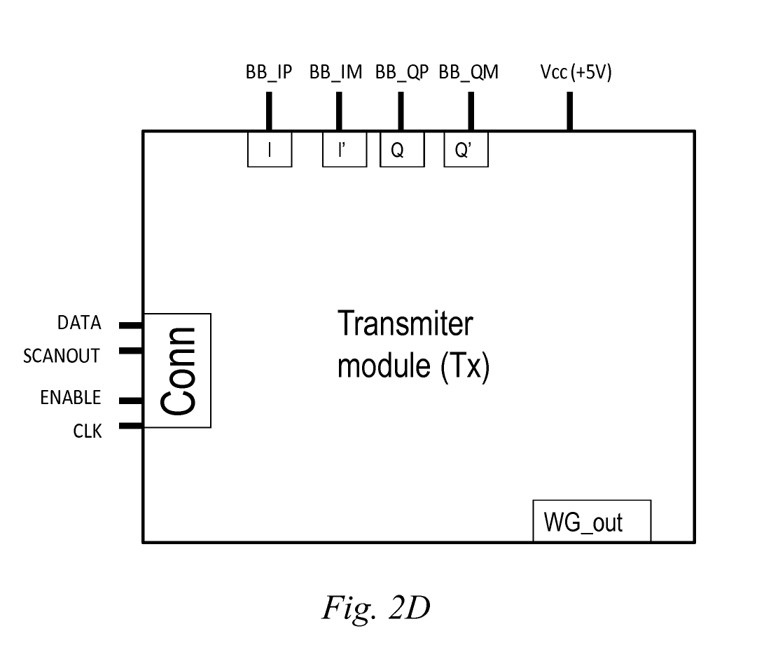

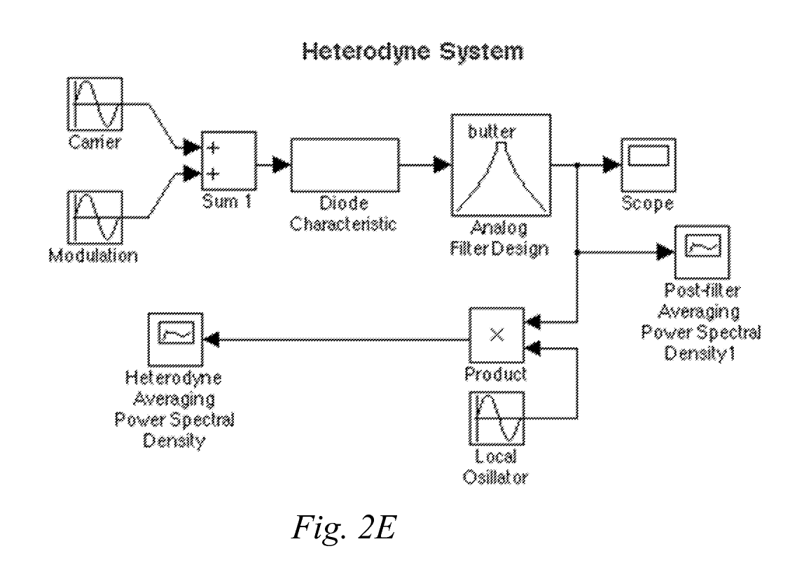

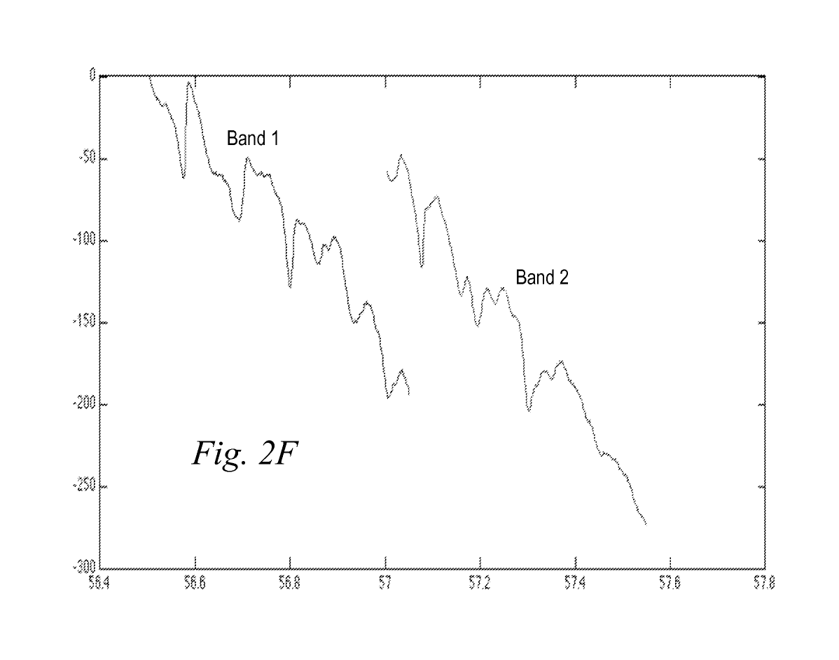

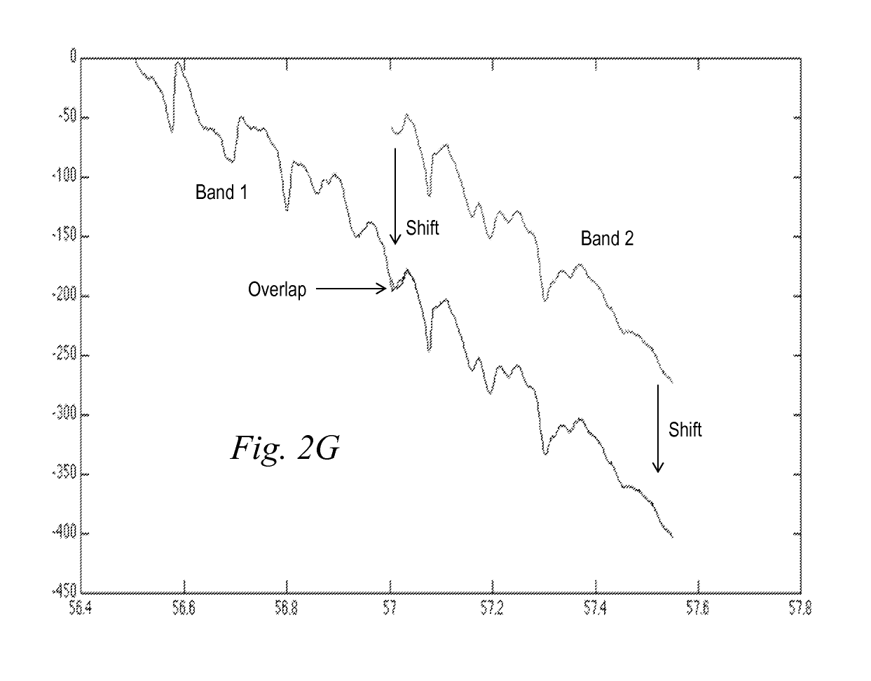

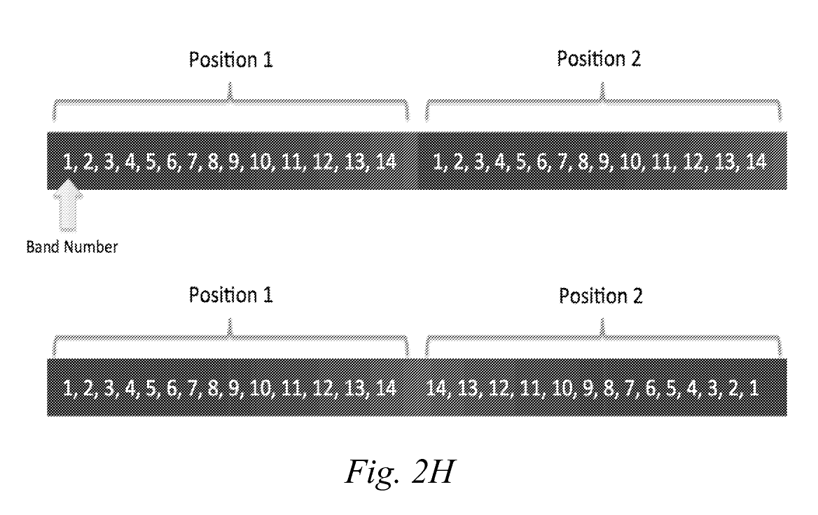

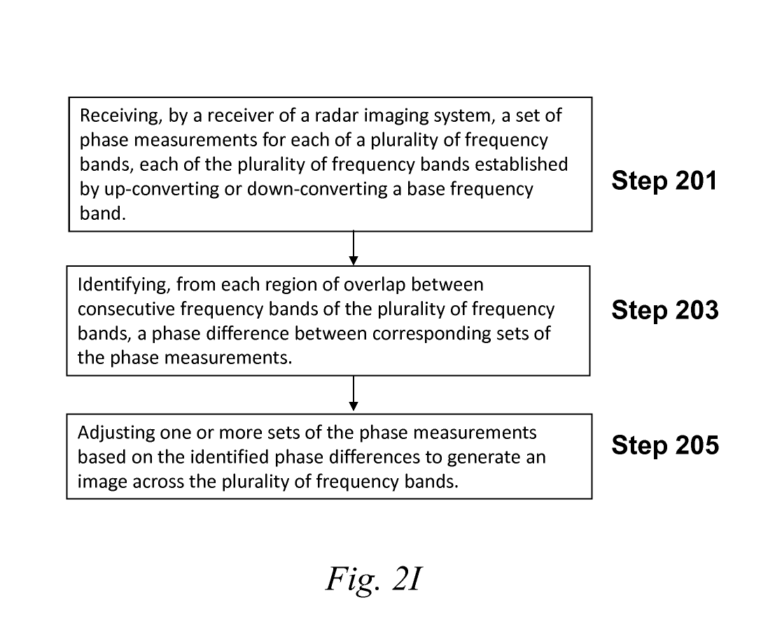

Referring to FIG. 2A, one embodiment of a wideband radar system for imaging is depicted. In brief overview, the system 211 may include one or more subsystems or modules, for example, one or more transmitters 230, one or more receivers 231 and/or one or more phase adjusters 250. Each of the transmitters and/or receivers may include or be associated with a frequency conversion module 240. The system may include at least one clock source/module 275 and a synchronization mechanism between transmitter and receiver modules. Each of these subsystems or modules may be controlled by, or incorporate a computing device, for example as described above in connection with FIGS. 1A-1C. The system may sometimes be referred to as an imaging system, a radar system, a radar imaging system or a radar system for imaging. The system may be configured to provide a wide and/or continuous operating system bandwidth (e.g., 3-10 GHz) for radar applications such as radar-based imaging. The system may be configured to provide a wide and/or continuous operating system bandwidth from a narrowband source/system.

In certain embodiments, the system comprises a millimeter-wave, microwave or other radar imaging system. The system may be built, designed and/or configured to comprise a low-cost, wide-bandwidth transceiver chipset, module, device or (integrated or distributed) system. For example, the system may be built, designed and/or configured for high-speed, indoor/outdoor and/or wireless/wired communication using the unlicensed 60 GHz band or another band. Some benefits of using an unlicensed band may include avoidance of interference and/or regulatory issues. In some instances, the present disclosure may reference a band with a specific center frequency (e.g., around 60 GHz or 77 GHz) and/or a specific bandwidth (e.g., 8 GHz), this is merely by way of illustration and not to be so limited. For example, the center frequency of the system may range between 20 GHz and 100 GHz, or any range within the radar spectrum and/or other frequency spectra. The operating band of the system may include frequencies from 55 to 65 GHz, 56.5 to 64.5 GHz, 57 to 65 GHz, or any range between 50 GHz and 80 GHz, between 20 GHz and 100 GHz, or any range within the radar spectrum and/or other frequency spectra. The operating or system bandwidth of the system (hereafter sometimes generally referred to as bandwidth), may for example include any value between the range of 2 GHz and 10 GHz, or any other ranges. In some embodiments, the bandwidth is established and/or configured based on the particular radar application. For example, to achieve a certain imaging resolution, coverage over certain operating frequencies and/or a particular bandwidth may be appropriate or required. By way of illustration, a 5 cm resolution may correspond to a 4 GHz bandwidth at the 60 GHz band. Embodiments of the system with a larger bandwidth may provide improved imaging resolution.

In one illustrative embodiments, the system may provide 8 GHz of bandwidth, which may comprise or be split into a plurality of (e.g., 16 or other number) bands (e.g., of 500 MHz or other bandwidth), in the 56.5-64.5 GHz range for example. Another illustrative system may provide 7 GHz of bandwidth, which may comprise or be split into 14 bands for example. Each of the bands (sometimes referred to as sub-bands) may have a same bandwidth or a different bandwidth as another of the bands. A band may have a bandwidth of, for example, 500 MHz, or any other value. In some embodiments, each band may comprise or have a bandwidth between 100 MHz and 1 GHz. The system bandwidth may be established using a baseband input signal in the range of 5-550 MHz for example. In some embodiments, a transmitter and a receiver of the radar system may operate on a common or reference clock. Transmitted and received signals may be sampled by the system, e.g., at the transmitter and receiver respectively. The system may include a phase adjuster, which comprises a phase coherence mechanism, to combine the plurality of bands (e.g., sixteen 500 MHz bands) into a wider, continuous imaging bandwidth (e.g., 8 GHz of imaging bandwidth).

In some embodiments or configurations, the system may calculate or otherwise determine the phase and/or amplitude of the channel for a single frequency, e.g., by comparing a transmitted signal to a corresponding received signal using a cross correlation algorithm. The system may perform imaging using the phase and/or amplitude calculation(s) for frequencies across the bandwidth. In some embodiments, having the bandwidth split into multiple bands may introduce an unknown and/or random phase offset between bands. For example, when the band is changed (e.g., when a new/additional band is established from a base band), the phase measurements between the initial band and the new band may include a phase jump or offset. Without removing this phase offset, the system may be able to image with each band individually, but not the full bandwidth. To address this, the system may compare an overlapping region between two consecutive or adjacent bands to determine the unknown phase offset.

In some embodiments, the system may incorporate hardware or components (e.g., intended for wireless applications) for stepped-frequency radar applications. For example, the system may incorporate hardware or components originally intended or configured for WirelessHD-type applications. The WirelessHD specification is based on a 7-8 GHz channel in the 60 GHz Extremely High Frequency radio band. The WirelessHD specification can allow either lightly-compressed or uncompressed digital transmission of high-definition video and audio and data signals, essentially making it equivalent of a wireless High-Definition Multimedia Interface (HDMI). This 60 GHz band may usually require line of sight between transmitter and receiver, and this limitation may be ameliorated via use of beam forming at the receiver and transmitter antennas to increase the signal's effective radiated power, find the best path, and/or utilize wall reflections. This technology may for example be used in in-room, point-to-point non-line of sight applications for ranges up to 10-15 meters. Due to the absorption of 60 GHz by the atmosphere (e.g., oxygen molecules) propagation of the radar may be limited, but may be suitable for the above applications. This 60 GHz band can be suitable for radar imaging applications (e.g., in the 1 m to 20 m range), such as portal-based, vehicular and/or passenger-related radar imaging

Referring to FIGS. 2B and 2C, embodiments of block diagrams of a wideband radar system for imaging is depicted. A transmitter and a receiver may be linked with a synchronization signal (clock 275) which is used for reference. The signal may comprise a very low frequency clock 275, e.g., as compared to conventional radar systems. A low frequency clock 275 may be made possible by the large up-conversion range of the system. In various embodiments, the clock 275 may for example comprise a frequency of 10 MHz, 100 MHz, 270 MHz or other value. The clock frequency may be low, e.g., at least one or two orders of magnitude lower than an operating/center frequency of the radar system. The clock 275 may comprise a frequency that is low enough to be transmitted or distributed via conventional and/or low-cost means, for example, via wired transmission (e.g., flexible, RF coaxial cable) or wirelessly (e.g., via GPS-based synchronization).

The clock distribution or synchronization may be performed via any wired or wireless means. The low frequency of the clock may allow one or more transmitters and/or receivers of the system to be flexibly configured. The low frequency of the clock may enable one or more transmitters and/or receivers of the system to be spatially located and/or moved into various monostatic, bi-static and/or multistatic configurations. For example, the one or more transmitters and/or receivers may be spaced far apart (e.g., on opposite sides of a target object or region to be scanned) without affecting or substantially affecting the clock synchronization. The one or more transmitters and/or receivers may be moved, individually or with respect to one another, within any time duration, e.g., without stressing or affecting the performance of the clock synchronization means (e.g., cables). In contrast, conventional radar system uses high-frequency clocks that requires complex and expensive means (e.g., high-frequency, rigid cables) for clock synchronization/distribution.

In some embodiments, each transmitter 230 and/or receiver 231 may include and/or employ an identical or matched synthesizer (e.g., depicted as Synth in FIGS. 2B and 2C). The synthesizer (sometimes referred to as a frequency conversion module 240) may be part of a transmitter or receiver, or may be a different module in communication with the transmitter or receiver. The frequency conversion module 240 may up-convert the clock reference from a low to a high frequency of operation. In some embodiments, the frequency conversion module 240 is configured to upconvert and/or downconvert a signal, e.g., from a base frequency band to one of a plurality of bands. By way of illustration, one embodiment of the system may employ a 285.714 MHz reference clock which can be up-converted to bands between 57 and 65 GHz. In certain embodiments, the synthesizer may include a multiplier (×N) and a divider stage (/M) for flexibility in conversion. By way of illustration, the following provides one implementation of the transmitter and receiver modules.

In some embodiments, the transmitter 230 receives an incoming signal (e.g., BB_IP/BB_IM, and BB_QP/BB_QM for the I and Q channels and their complements, respectively, as depicted in FIG. 2B), that may be up-converted by the clock frequency. The upconverted signal may be amplified by an intermediary lower frequency Variable Gain Amplifier (IF VGA). Filtering may be applied to the amplified and/or up-converted signal to maintain a desired frequency band. The filtered signal may be mixed/up-converted (again) and/or amplified via a Power Amplifier (PA) before being sent to the Transmit antenna (Tx).

In some embodiments, the receiver 231 receives a signal (e.g., corresponding to a signal transmitted by the Transmit antenna). The received signal may be incoming from a target object or region to be imaged, responsive to the transmitted signal. The radar system may include internal power calibration, which can allow tuning of the radar to the various targets examined. The system can include self-calibration mechanisms that run on system startup, on a fixed time interval, or on an event-by-event basis. Such mechanisms can be programmed into the embedded hardware and/or software of the radar system. The received signal may be amplified via a Low Noise Amplifier (LNA). The reverse of the transmittal may be applied to the amplified signal. For example, the signal may be filtered and down-converted to lower frequency bands, after which may be filtered in low frequency bands before being amplified by a baseband VGA. Finally, the signal may be sent out to a sampling stage at the output of the receiver module.

An illustrative embodiment of connections related to the transmitter module is depicted in FIG. 2D. The transmitter may include two baseband differential quadrature inputs (corresponding to BB_JP, BB_IM, BB_QP, and BB_QM, respectively). A power supply (e.g., 5.0V DC) may be supplied to the transmitter (e.g., to the system/device board on which the transmitter module is mounted/implemented, the power supply supplied through a screw-type connector). Voltage regulators (e.g., on-board voltage regulators) may supply 1.2V, 2.7V, and 4V to the transmitter (e.g., transmitter chip module) and 3.3V to the EC L clock buffers. In addition, the power supply (e.g., 5.0V DC) may be used for one or more logic buffers for a serial interface. The regulators may have trimmer potentiometers to adjust their output voltages. Current from the 5 V supply may be approximately 0.30 A with the transmitter powered off through the serial interface, because of current drawn by the EC L clock buffers and/or voltage regulators. Current may be 0.56 A with the transmitter on (and no input signal for example). An LED may light up when the power supply is applied.

In some embodiments, and by way of illustration, the serial interface may be accessed through a 2×5 header plug. Logic buffers on the board may translate the 1.2 V CMOS levels at the transmitter module/IC inputs and outputs to 5 V TT L/CMOS levels at a header plug to be compatible with a parallel port of a personal computer. A row of pins closest to the board edge may be connected to ground. In an illustrative embodiment, pin JP13 is DATA, JP11 is CLK, JP14 is ENABLE, and JP15 is the transmitter SCANOUT. JP16 may not be used for the transmit board. A ribbon cable with a 2×5 header plug on one end and a male DB25 connector on the other end, for example, may be supplied with the board to connect it to the PC parallel port when using supplied software (e.g., supporting the present methods and systems). The ribbon cable may be installed, and the ribbon may lead out away from the board/PCB (rather than over it for example). The ribbon cable may connects pin JP13 (DATA) to pin 2 on the parallel port, JP11 (CLK) to pin 3, JP14 (ENABLE) to pin 4, JP16 to pin 10, and JP15 (Tx SCANOUT) to pin 12. The ribbon cable may make numerous ground connections.

In some embodiments, and by way of non-limiting illustration, the board has a 285.714 MHz crystal installed as a frequency reference for the synthesizer. With this crystal, each transmitter and/or receiver may for example tune from 56.5 GHz to 63 GHz in 500 MHz digitally-controlled steps. In addition to the on-board crystal, there is an option of using an external synthesizer as a frequency reference. This option might be useful in order to phaselock the synthesizer to an external ADC sample clock, or to tune in steps other than 500 MHz, for example. To use an external reference, an additional connector may be installed at J23 (ALTR FCLK) and two jumpers may be changed on the board/PCB.

In some embodiments of the receiver, and by way of non-limiting illustration, there are two baseband differential quadrature outputs (e.g., connectors J8, J7, J5, J2, corresponding to VOUT QM, VOUT QP, VOUTI M, and VOUTI P, respectively) on a board on which the receiver is mounted/implemented. Matched cable lengths can provide optimal performance at Gb/s data rates. Similar to the transmitter board, power (e.g., 5V DC) may be supplied to the board (e.g., through a screw-type connector, J14). A current-limited 5 V supply may be appropriate or recommended. Voltage regulators may supply 1.2V and 2.7V to the receiver module/chip, and 3.3V to EC L clock buffers. In addition, the power supply may be used for logic buffers for a serial interface. The regulators may have trimmer potentiometers to adjust their output voltages. Current from the power supply (e.g., 5 V supply) may be approximately 0.30 A with the receiver module powered off through the serial interface, because of current drawn by the EC L clock buffers and/or voltage regulators. Current may be 0.55 A with the receiver module/IC powered on. An LED (D6) may light up when power is applied.

In certain embodiments, the serial interface may be accessed through a 2×5 header plug for example. Logic buffers on the receiver board may translate the 1.2 V CMOS levels at the IC inputs and outputs to 5 V TT L/CMOS levels at the header plug to be compatible with a parallel port of a personal computer. A row of pins on the board (e.g., closest to the board edge) may be connected to ground. By way if illustration, pin JPS is DATA, JP3 is CLK, JP6 is ENA BLE, and JP7 is the receiver SCANOUT. JP9 may not be used for the receiver/transmit board. A ribbon cable with a 2×5 header plug on one end and a male DB25 connector on the other end is included, for example. The ribbon cable may be installed such that it leads out away from the board/PCB (rather than over it).

Embodiments of the present systems and methods may include a superheterodyne system, in which a high frequency is downconverted through a mixer to a low frequency which can then be processed by a digitizer for example. FIG. 2E depicts one embodiment of a superheterodyne system which may be adapted or customized for use in certain embodiments of the present systems. For example, the analog filter design, diode characteristics or averaging functions can incorporate features configured or customized for the present systems and methods.

In some aspects of the present system, a band of frequencies may be up-converted and/or down-converted (e.g., by the synthesizer) to a lower frequency where they can be properly processed. The band of frequencies may be simultaneously up-converted and/or down-converted. This multi-frequency per band operation has an advantage of speed as an entire band may be processed at one time and the multi-band shifting or phase adjustment is only done based on the number of bands (e.g., a total of 16 times for 16 bands). In contrast, a typical stepped-frequency system may require switching to be performed for each separate discrete frequency.

As described earlier, the present systems and methods can make use of multiple channels or bands of frequency to form a continuous operating bandwidth. By way of illustration, a 8 GHz of bandwidth may formed from 16 partially overlapping 550 MHz bands. The system may coordinate between these channels by determining a common phase offset for or within each band. The system may determine, calculate or otherwise measure the phase of a channel by comparing the phase of a direct signal path to that of a path through the radar system modules. The phase measurement technique may work for frequencies within the same band. However, an unknown and/or random phase offset may be introduced when bands are switched, and may invalidate any comparisons of phase between frequencies in different bands. For example, the unknown and/or random phase offset may be introduced in part because the path through the radar system modules is altered in an unknown and/or random manner, responsive to a switch between bands.

FIG. 2F depicts one embodiment of phase measurements acquired for frequencies across two bands. The phase measurements may be collected or acquired by an uncalibrated system, e.g., such that there is a random phase offset. A frequency [GHz] vs phase [degree] plot of the measurements is depicted. The left portion of the measurements corresponds to a first band, and the right portion of the measurements correspond to a second band. It may be noted that phase measurements within each individual band are continuous, but there is a jump or offset in phase between bands, e.g., when the system switches operation from one band to another in a transmitter/receiver.

In some embodiments, the present system uses an overlapping frequency range (e.g., 50 MHz, 45 MHz or other extent of overlapping frequency signal) between consecutive bands (e.g., the last 50 MHz of the previous and first 50 MHz of the successive band), to determine a correction or adjustment to resolve the unknown phase offset between the bands. An overlapping frequency range may exist or be created between bands, for example, by configuring the frequency conversion of the system or otherwise. A phase measurement taken at a particular frequency, irrespective of the band it was observed, should remain the same. Accordingly, the phase measurements in one or both of the bands can be shifted (e.g., with respect to each other) to result in the overlapping region having the same phase.

FIG. 2G depicts one embodiment of phase measurements acquired for frequencies across two bands that are adjusted for a phase offset between the two bands. The phase measurements on the right, corresponding to those on the right of FIG. 2G, may be shifted (e.g., downwards) to overlap or coincide with the phase measurements on the left, resulting in a continuous set of phase measurements (e.g., phase offset is removed or minimized). In some embodiments, a phase adjuster of the system may be configured to shift or adjust phase measurements of at least one band by an appropriate amount so there is agreement in the phase at the overlapping frequencies. This process can then be repeated for remaining bands, resulting in a continuous bandwidth (e.g., of 8 GHz). This phase stitching can allow rapid band-transition and the extension of individual bands into a multi-band, high-bandwidth radar system.

In further details, the phase shifter may incorporate an algorithm or software for comparing phase differences between sets of phase measurements corresponding to different bands. For example the phase shifter may be configured to match a portion of two sets of phase measurements corresponding to one or more overlapping frequencies between two bands. The phase shifter may determine or calculate a difference or offset in phase between two sets of phase measurements at an overlapping frequency. The phase shifter may determine or calculate a phase offset that minimizes the phase difference between two sets of phase measurements at one or more overlapping frequencies. For example, the phase shifter may utilize a means-square error function, or other function, to identify a phase adjustment or correction that minimizes or removes discrepancy between the two sets of measurements in the overlapping region. The phase shifter may determine an average phase offset among pairs of phase measurements at overlapping frequencies. In some embodiments, the phase shifter may use a graphical analysis tool to map, superimpose, shift or coincide a phase measurement plot based on one set of measurements to that of another set.

The present systems and methods may provide certain benefits and advantages over other implementations. For example, some microwave and millimeter-wave radar has been implemented using complex homodyne architectures, and typically using the Frequency Modulated Continuous Wave (FMCW) principle. In FMCW (IEEE Std. 686-2008), the frequency is generally changed in a linear fashion, so that there is an up-and-down or a sawtooth-like sweep in frequency. If the frequency is continually changed with time, the frequency of the echo signal can differ from that transmitted, and the difference Δf can be proportional to round trip time Δt and so can the range R of the target. When a reflection is received, the frequencies can be examined, and by comparing the received echo with the actual step of transmitted frequency, a range calculation can be performed, similar to using pulses. Accordingly, measuring the difference between the transmitted and received frequencies can give the range to the stationary target. It is however generally not easy to create a transmitter or broadcaster that can send out random frequencies cleanly, so instead these frequency-modulated continuous-wave radar may use a smoothly varying “ramp” of frequencies up and down. If the frequency modification is linear over a wide area, the distance can be determined within this region in a simple way by a frequency comparison. Since only the absolute value of the difference can be measured, the results with increasing frequency modification equal to a decreasing frequency change at a static scenario. Sawtooth modulation forms are preferred for imaging radar; triangular shaped modulation is used more for non-imaging radars. In an FMCW radar, the distance measurement may be done by comparing the actual frequency of the received signal to a given reference (e.g., a directly transmitted signal). The duration of the transmitted signal may be much larger than the time required for measuring the installed maximum range of the radar. By suitable choice of frequency deviation per time unit, the radar resolution can be varied, and by choice of the duration of the time of the frequency shift, the maximum range can be varied. The amount of frequency modulation must be significantly greater than the expected Doppler shift or the results may be affected. One way is to modulate the wave is to linearly increase the frequency. In other words, the transmitted frequency may change at a constant rate.

FMCW systems can have different requirements on co-location of transmit/receive. For example, there may be a requirement of locating transmit and receive subsystems close to each other since the phase distribution between the transmit and receive must be locked together at high frequency. In contrast, the present systems affords greater flexibility with regard to physical and spatial configuration of transmitter and receiver elements/modules, as discussed earlier.

In conventional radar systems, the real total bandwidth is achieved at a high cost to the hardware infrastructure. For example, radar that presents a continuous bandwidth of 8-10 GHz at a center frequency of 60 GHz may require highly customized, tuned, and calibrated sub-components to ensure that subcomponents function across the desired range. Due to RF/microwave/millimeter-wave practical implementation details, such implementations of hardware are complex and costly. For example, components typically present optimum operation at a single frequency and this degrades further away from the optimum point. Therefore, when trying to create a large bandwidth system there are substantial challenges involved around the hardware design, manufacturing feasibility, and tolerances, etc.

In the present systems, modular multi-bandwidth architecture allows expansion of the total or effective operating system bandwidth from a plurality of sub-bands. Some embodiments of the present system feature a single chip radar module. The present system may be compact, and can be easily integrated with antenna and mounting structure. The present system can provide flexibility in configuration (e.g., various monostatic, bistatic and/or multistatic possibilities). For example, with a multi-transmitter and/or multi-receiver implementation, the system can improve image quality and/or reduce scanning time. With the dual up-down converting setup described above, there can be substantial flexibility in configuration and/or positioning of the transmitter and receiver subsystems as they can be connected or synchronized through low-cost, low-complexity means. The phase alignment or adjustment between receiving and transmitting modules may be done at low frequency, which allows for easy synchronization between transmitting and receiving modules. Because the clock signal is relatively low RF frequency, the clock can be passed to widely separated receiver and transmitter modules. On the other hand, the system performance of other types of systems (e.g., FMCW) is highly dependent on the link between transmit and receive.

The present systems can be built at low cost (e.g., one or more orders of magnitude lower in cost to build than other radar systems). In some embodiments, and by way of non-limiting illustration, the system core for the transmit or receive module may be comprised of a 3×1×0.5 mm on-chip design (Monolithic Microwave Integrated Circuit—MMIC) which can perform all fundamental functions of the radar. The remaining circuitry may be used for supporting the functionality of the radar modules (e.g., power, transmit/receive input/output, antenna connection, etc.). The system can alternatively be implemented on a discrete microwave-integrated-circuit (MIC) or module MIC design.

A MMIC is a type of integrated circuit (IC) device that may operate at microwave frequencies (300 MHz to 300 GHz). These devices can perform functions such as microwave mixing, power amplification, low noise amplification, and high frequency switching. Inputs and outputs on MMIC devices may be matched to a characteristic impedance of 50 ohms for example. This makes them easier to use, as cascading of MMICs does not require an external matching network. Additionally, most microwave test equipment is designed to operate in a 50 ohm environment. A MIC, in comparison, may be an IC designed for operation at frequencies of approximately 1 GHz or more. Such components can be physically small, in some cases having less than one square millimeter (1 mm²) of surface area. Relative to a module-based radar design, an MIC can have fewer parts, higher yields (and lower cost), higher reliability, and/or require less in-field service.

In some embodiments, the system may tightly integrate the transmit/receive components into a very compact, low-cost package. The package may be encapsulated with high thermal conductivity materials for heat dissipation, improving longevity of the electronic components in the field. Antennas may for example be part of the package (receiver), or a feeding mechanism can be created that would match the antenna system (receiver). In certain embodiments, the system may incorporate embedded software or algorithms with the radar sensor hardware.

In some embodiments, the system may be configured to use multiple transmitters and/or receivers configured in an array. The system may be configured to synchronize the phase between these modules. For example, phase jumps or offsets can occur between bands (e.g., on a single chip), as well as between the modules (e.g., between chips). The system may be configured to incorporate one or more of the following methods to synchronize the phase between modules.

In one embodiment, a single transmitter (at a known location) can directly illuminate the receivers concurrently, thereby allowing the system to compare the phase of the receivers. This can also be implemented in reverse for transmitters (e.g., a single receiver can receive from all transmitters). In the latter, the system may for example step through the operation of each transmitter in time, instead of transmitting from all transmitters at the same time.

In another embodiment, the system can leverage on a known fiducial or reference located somewhere in the imaging region (e.g., a metal pole or sphere), allowing the system to calibrate its hardware as a pre-processing step to the imaging algorithm.

In yet another embodiment, the system can use or include a camera or depth sensor to locate and use part of the imaging target as a fiducial/reference. This is similar to the prior embodiment, except that instead of having a known or predetermined fixed point fiducial/reference, the system can find one to use during data collection using the camera or sensor.

Referring now to FIG. 2H, synchronized operation between bands of a transmitter and a receiver is depicted. The system may for example support radar imaging across 14 sub-bands over the operating bandwidth of the system. The transmitter and the receiver may be arranged or configured in a first position relative to each other, and the transmitter and the receiver may operate in synchronization at the same band (e.g., band 1). The system may synchronize switching of bands in the transmitter and the receiver, e.g., over the operating bandwidth of the system. The system may repeat this operation when the transmitter and the receiver are arranged or configured in a second position relative to each other.

Referring now to FIG. 2I, one embodiment of a method for establishing a wideband radar system for imaging is depicted. A receiver of a radar imaging system may receive a set of phase measurements for each of a plurality of frequency bands (201). Each of the plurality of frequency bands may be established by up-converting or down-converting a base frequency band. A phase adjuster of the radar imaging system may identify, from each region of overlap between consecutive frequency bands of the plurality of frequency bands, a phase difference between corresponding sets of the phase measurements (203). The phase adjuster may adjust one or more sets of the phase measurements based on the identified phase differences to generate an image across the plurality of frequency bands (205).

Referring now to (201), and in some embodiments, a receiver of a radar imaging system may receive a set of phase measurements for each of a plurality of frequency bands. The receiver may comprise a receiver of a multistatic or bistatic radar imaging system. The receiver may be one of a plurality of receivers of the imaging system. Each of the plurality of frequency bands may be established by up-converting and/or down-converting a base frequency band. A frequency conversion module of the system may apply frequency conversion to the base frequency band, for example, at a corresponding transmitter. The frequency conversion module upconverts and/or downconverts a signal, e.g., from a base frequency band to one of a plurality of bands. For example, the frequency conversion module may up-convert and/or down-convert a baseband input signal in the range of 5-550 MHz. The input signal may be up-converted using a reference clock. The frequency conversion module may up-convert the reference clock from a low to a high frequency of operation. Using the reference clock, each transmitter and/or receiver of the system may for example tune from 56.5 GHz to 63 GHz in digitally-controlled steps of 500 MHz.

The system may generate the reference clock, or receive the reference clock from an external source. The system may provide the reference clock, wirelessly or via a wired line (e.g., RF coaxial cable), to the receiver and the transmitter. The reference clock may comprise a very low frequency clock, e.g., as compared to conventional radar systems. Use of a low frequency clock may be made possible by the large up-conversion range of the system. In various embodiments, the reference clock may for example comprise a frequency of 10 MHz, 100 MHz, 270 MHz or other value. The reference clock frequency may be at least one or two orders of magnitude lower than an operating/center frequency of the system. The reference clock may comprise a frequency that is low enough to be transmitted or distributed via conventional and/or low-cost means, for example, via wired transmission (e.g., flexible, coaxial cable) or wirelessly (e.g., via GPS-based synchronization).

The low frequency of the reference clock may allow one or more transmitters and/or receivers of the system to be flexibly configured. The low frequency of the reference clock may enable the one or more transmitters and/or receivers of the system to be spatially located and/or moved into various monostatic, bi-static and/or multistatic configurations. For example, the one or more transmitters and/or receivers may be spaced far apart, e.g., on opposite sides of a target object or region to be scanned, without affecting or substantially affecting the clock synchronization. The one or more transmitters and/or receivers may be moved, individually or with respect to one another, within any time duration, e.g., without stressing or affecting the performance of the clock synchronization.

The receiver may receive a signal corresponding to a signal transmitted by a transmitter of the system. In some embodiments, the receiver may receive a signal produced from a signal transmitted from a transmitter of the radar imaging system at a corresponding frequency band of the plurality of frequency bands. The transmitter may be located at a first location and the receiver may be located at a second location spatially separated from the first location, e.g., as described above. The received signal may be incoming from a target object or region to be imaged, responsive to the transmitted signal. The received signal may be filtered and down-converted to lower frequency bands, after which it may be filtered in low frequency bands before being amplified by a baseband VGA. The amplified signal may be sent out to a sampling stage at the output of the receiver. The signal may comprise one or more sets of phase measurements corresponding to one or more of the plurality of bands.

The receiver may receive and/or generate a set of phase measurements for each of the plurality of frequency bands. The plurality of frequency bands may form a continuous frequency band with a center frequency between 50 GHz and 80 GHz for example. Each of the plurality of frequency bands may have at least a predefined extent of overlap with at least another of the plurality of frequency bands. For example, the frequency conversion module may establish the plurality of frequency bands to have overlapping regions between consecutive bands.

Referring now to (203), and in some embodiments, a phase adjuster of the radar imaging system may identify, from each region of overlap between consecutive frequency bands of the plurality of frequency bands, a phase difference between corresponding sets of the phase measurements. The phase adjuster may comprise a phase coherence mechanism to combine the plurality of bands (e.g., sixteen 500 MHz bands) into a wider, continuous imaging bandwidth (e.g., 8 GHz of imaging bandwidth). The phase adjuster may compare an overlapping region between two consecutive or adjacent bands to determine an unknown and/or random phase offset between these bands. The phase adjuster may to determine a correction or adjustment based on the comparison, e.g., to resolve the phase offset between the bands.

In further details, the phase adjuster may identify, at a frequency within the region of overlap, a difference in phase values between the corresponding sets of the phase measurements. The phase shifter may incorporate an algorithm or software for comparing phase differences between sets of phase measurements corresponding to different bands. For example the phase shifter may be configured to compare and/or match a portion of two sets of phase measurements corresponding to one or more overlapping frequencies between two bands. The phase shifter may determine or calculate a difference or offset in phase between two sets of phase measurements at an overlapping frequency. The phase shifter may determine or calculate a phase offset that minimizes the phase difference between two sets of phase measurements at one or more overlapping frequencies. For example, the phase shifter may utilize a means-square error function, or other function, to identify a phase adjustment or correction that minimizes or removes discrepancy between the two sets of measurements in the overlapping region. The phase shifter may determine an average phase offset among pairs of phase measurements at overlapping frequencies.

Referring now to (205), and in some embodiments, the phase adjuster may adjust one or more sets of the phase measurements based on the identified phase differences to generate an image across the plurality of frequency bands. Phase differences detected between the plurality of frequency bands can be removed or minimized based on the identified phase differences. Because phase measurement taken at a particular frequency should remain the same irrespective of the band it was observed, the phase adjuster may shift or adjust the phase measurements in one or both of the bands (e.g., with respect to each other) based on the identified phase differences. The phase adjuster may shift or adjust the phase measurements so that they coincide, or substantially coincide, within the overlapping region. The phase adjuster of the system may shift or adjust the phase measurements of at least one band by an appropriate amount so there is agreement in the phase at the overlapping frequencies. In some embodiments, the phase shifter may use a graphical analysis tool to map, superimpose, shift or connect a phase measurement plot based on one set of measurements to that of another set.

This process can be repeated for remaining bands, resulting in a continuous bandwidth (e.g., of 8 GHz). The phase adjuster may minimize differences between the sets of phase measurements within the regions of overlap, for example as described above in connection with at least FIGS. 2F and 2G. This phase stitching can allow rapid band-transition and the extension of individual bands into a multi-band, high-bandwidth radar system. The phase adjuster may generate a combined or continuous set of phase measurements across the plurality of frequency bands, based on removal or minimization of each identified phase difference. The radar imaging system may generate the image based on the combined or continuous set of phase measurements.

It should be noted that certain passages of this disclosure can reference terms such as “first” and “second” in connection with receivers, transmitters, etc., for purposes of identifying or differentiating one from another or from others. These terms are not intended to merely relate entities (e.g., a first receiver and a receiver sensor) temporally or according to a sequence, although in some cases, these entities can include such a relationship. Nor do these terms limit the number of possible entities (e.g., receivers) that can operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A method for establishing a wideband radar system for imaging, comprising:
(a) receiving, by a receiver of a radar imaging system, a set of phase measurements for each of a plurality of frequency bands, each of the plurality of frequency bands established by up-converting or down-converting a base frequency band;
(b) identifying, from each region of overlap between consecutive frequency bands of the plurality of frequency bands, a phase difference between corresponding sets of the phase measurements; and
(c) adjusting one or more sets of the phase measurements based on the identified phase differences to generate an image across the plurality of frequency bands.

2. The method of claim 1, wherein (a) comprises receiving a signal produced from a signal transmitted from a transmitter of the radar imaging system at a corresponding frequency band of the plurality of frequency bands, wherein the transmitter is located at a first location and the receiver is located at a second location spatially separated from the first location.

3. The method of claim 2, further comprising providing, wirelessly or via coaxial cable, the receiver and the transmitter with a same reference clock corresponding to the base frequency band.

4. The method of claim 1, wherein (a) comprises receiving, by a receiver of a multistatic or bistatic radar imaging system, the set of phase measurements.

5. The method of claim 1, wherein (a) comprises receiving a set of phase measurements for each of the plurality of frequency bands, the plurality of frequency bands forming a continuous frequency band with a center frequency between 50 GHz and 80 GHz.

6. The method of claim 1, wherein (a) comprises establishing the plurality of frequency bands, each of the plurality of frequency bands having at least a predefined extent of overlap with at least another of the plurality of frequency bands.

7. The method of claim 1, wherein (b) comprises identifying, at a frequency within the region of overlap, a difference in phase values between the corresponding sets of the phase measurements.

8. The method of claim 1, wherein (c) comprises minimizing differences between the sets of phase measurements within the regions of overlap.

9. The method of claim 1, further comprising generating a combined or continuous set of phase measurements across the plurality of frequency bands, based on removal or minimization of each identified phase difference.

10. The method of claim 9, further comprising generating, by the radar imaging system, the image based on the combined or continuous set of phase measurements.

11. A wideband radar system for imaging, comprising:
a receiver receiving a set of phase measurements for each of a plurality of frequency bands;
a frequency conversion module, for the receiver, establishing each of the plurality of frequency bands by up-converting or down-converting a base frequency band; and
a phase adjuster:
identifying, from each region of overlap between consecutive frequency bands of the plurality of frequency bands, a phase difference between corresponding sets of the phase measurements; and
adjusting one or more sets of the phase measurements based on the identified phase differences to generate an image across the plurality of frequency bands.

12. The system of claim 11, wherein the receiver receives a signal produced from a signal transmitted from a transmitter of the radar imaging system at a corresponding frequency band of the plurality of frequency bands, the transmitter located at a first location and the receiver located at a second location spatially separated from the first location.

13. The system of claim 12, wherein the frequency conversion module for the receiver and a frequency conversion module for the transmitter receive a same reference clock wirelessly or via coaxial cable, the reference clock corresponding to the base frequency band.

14. The system of claim 11, wherein the receiver comprises a receiver of a multistatic or bistatic radar imaging system.

15. The system of claim 11, wherein the receiver receives a set of phase measurements for each of the plurality of frequency bands, the plurality of frequency bands forming a continuous frequency band with a center frequency between 50 GHz and 80 GHz.

16. The system of claim 11, wherein the frequency conversion module establishes the plurality of frequency bands, each of the plurality of frequency bands having at least a predefined extent of overlap with at least another of the plurality of frequency bands.

17. The system of claim 11, wherein the phase shifter identifies, at a frequency within the region of overlap, a difference in phase values between the corresponding sets of the phase measurements.

18. The system of claim 11, wherein the phase shifter minimizes differences between the sets of phase measurements within the regions of overlap.

19. The system of claim 11, wherein the phase shifter generates a combined or continuous set of phase measurements across the plurality of frequency bands, based on removal or minimization of each identified phase difference.

20. The system of claim 19, wherein the radar imaging system generates the image based on the combined or continuous set of phase measurements.
